(19) United States
(12) Patent Application Publication
(10) Pub. No.: US 2004/0193532 A1
(43) Pub. Date: Sep. 30, 2004

(54) Insider trading risk management

(76) Inventor: David Lawrence, New York, NY (US)

Correspondence Address: CLIFFORD CHANCE US LLP, 31 WEST 52ND STREET, NEW YORK, NY, 10019-6131, US

(21) Appl. No.: 10/775,868

(22) Filed: Feb. 10, 2004

Related U.S. Application Data
(63) Continuation-in-part of application No. 10/074,584, filed on Feb. 12, 2002.
Application No. 10/074,584 is a continuation-in-part of application No. 10/021,124, filed on Oct. 30, 2001.
Application No. 10/021,124 is a continuation-in-part of application No. 09/812,627, filed on Mar. 20, 2001.
(60) Provisional application No. 60/446,127, filed on Feb. 10, 2003.

(51) Int. Cl. G06F 17/60

(52) U.S. Cl. 705/37

(57) ABSTRACT

Methods and systems are disclosed for facilitating the detection and reporting of insider trading activities. Digital information related to one or more financial transactions is received into a computer and rules are created that relate the digital information to insider trading laws. An indication that that execution of the financial transaction is in violation of one or more of the insider trading rules is generated by the computer. The digital information can include, for example, supporting documentation for the transactions. An action responsive to a particular legal violation can also be generated. In some embodiments, an indication to block execution of the one or more financial transactions can be generated and transmitted. A legal authority involved in enforcing insider trading laws can also be apprised of a potential violation of a law which relates to the execution of the financial transaction.

### CROSS REFERENCE TO RELATED APPLICATIONS

The present invention claims priority from pending U.S. Provisional Serial No. 60/446,127 entitled “Insider Trading Risk Management,” filed Feb. 10, 2003. This application also is a continuation-in-part of a prior application entitled “Risk Management Clearinghouse” filed Feb. 12, 2002, and bearing the Ser. No. 10/074,584, which is a continuation-in-part of a prior application entitled “Risk Management Clearinghouse” filed Oct. 30, 2001, and bearing the Ser. No. 10/021,124, which is also a continuation-in-part of a prior application entitled “Automated Global Risk Management” filed Mar. 20, 2001, and bearing the Ser. No. 09/812,627, all of which are relied upon and incorporated by reference.

### FIELD

The present invention relates to computerized database and communication systems. In particular, the present invention relates to systems and methods to facilitate managing risk associated with insider trading risk (ITR) issues.

### BACKGROUND

This invention relates generally to a method and system for facilitating the identification, investigation, assessment and management of legal, regulatory financial and reputational risks (“Risks”). In particular, the present invention relates to a computerized system and method for banks and non-bank financial institutions to access information compiled on a worldwide basis and relate such information to a risk subject, such as a transaction at hand, wherein the information is conducive to quantifying and managing financial, legal, regulatory and reputational risk associated with the transaction.

Recent events have led to an increased scrutiny of risks associated with insider trading issues and whether actions taken on by, or on behalf of: corporations, analysts, traders and others are consistent with insider trading rules. Insider trading rules can to address diverse issues including: selective disclosure by issuers of material nonpublic information; when insider trading liability arises in connection with a trader's “use” or “knowing possession” of material nonpublic information; and when the breach of a family or other non-business relationship may give rise to liability under the misappropriation theory of insider trading.

Bank and non-bank financial institutions, including: investment banks; merchant banks; commercial banks; securities firms, including broker dealers securities and commodities trading firms; asset management companies, hedge funds, mutual funds, securities exchanges and bourses, institutional and individual investors, law firms, accounting firms, auditing firms, any institution the business of which is engaging in financial activities as described in section 4(k) of the Bank Holding Act of 1956, and other entities subject to legal and regulatory compliance obligations with respect to ITR, hereinafter collectively referred to as “Financial Institutions,” typically have few resources available to them to assist in the identification of present or potential risks associated with business transactions. Risk can be multifaceted and far reaching.

Generally, despite this high standard of scrutiny related to insider trading issues personnel do not have available a mechanism to provide real time assistance to assess a risk factor or otherwise qualitatively manage risk. In the event of problems, it is often difficult to quantify to regulatory bodies, shareholders, newspapers and other interested parties, the diligence exercised by the Financial Institution to properly identify and respond to risk factors. Absent a means to quantify good business practices and diligent efforts to contain risk, a financial institution may appear to be negligent in some respect.

### SUMMARY

Accordingly, the present invention includes methods and system for facilitating the detection and reporting of insider trading activities. Digital information related to one or more financial transactions is received into a storage of a computer device where rules are created that relate the digital information to insider trading rules. An indication that that execution of the financial transaction is in violation of one or more of the insider trading rules can be generated by the computer. The digital information can include, for example, supporting documentation for the transactions.

The indication of an amount of risk can include, for example, a normal range of risk and an elevated amount of risk and the method can additionally include determining a particular legal violation associated with an elevated level of risk and generating an action responsive to the particular legal violation.

In some embodiments of the present invention, an indication to block execution of the one or more financial transactions can be generated and transmitted. Still other embodiments can include notifying a legal authority involved in enforcing insider trading laws of a potential violation of a law related to the execution of the financial transaction.

In another aspect, some embodiments can include the digital information being received from at least one of: (i) a bank, (ii) a broker dealer, and (iii) a national trading exchange.

Still other aspects can include analyzing the stored data for patterns of behavior indicative of insider trading and automatically generating a suggested action based upon the data. The suggested action can include, for example: conveying an insider trading report to a government entity. (ii) initiating a risk management clearinghouse search, (iii) monitoring an associated account, (iv) monitoring an associated entity, (v) refusing to perform a requested transaction, (vi) closing an associated account, and (vii) conveying insider trading report to an associated trading exchange. he method of claim 7, wherein the suggested action comprises initiating a risk management clearinghouse search.

In some embodiments of the present invention, the insider trading report can transmitted, for example, via electronic mail, by facsimile, via voice communications, or any data communication medium. Some embodiments can also include a record of the date and time of the transmission and storing a record of a destination of the transmission.

In another aspect, the step of securing the data included in the insider trading report can be accomplished with one or more of: (i) encrypting the data, (ii) password protecting the data, (iii) protecting the data with a biometric access procedure, and (iv) refusing to disclose the data except where such disclosure is requested by an appropriate law enforcement or bank supervisory agency.

In other aspects of the present invention, a method of facilitating filing insider trading report can include presenting an electronic form to a computer operator for receiving information into an the electronic form with prompts directed to receiving information related to determining whether insider trading. Data responsive to the prompts can be received, as can data identifying documentation supporting potential insider trading activity. The data responsive to the prompts and the data identifying documentation can be stored in a computer database and presented to a person designated with determining whether to proceed with the one or more transactions. An indication to proceed with the one or more transactions can be received and a communication can be generated with an instruction to proceed with the transactions.

Still other embodiments can include scrubbing the data responsive to the prompts and the data identifying documentation to obtain additional related data. Some embodiments can also include automatically initiating a risk management clearinghouse search or a proprietary risk management clearinghouse system search, related to at least one of (i) the data responsive to the prompts, and (ii) the data identifying documentation. Other embodiments will be apparent in the following description and claims, as well as the accompanying diagrams.

### BRIEF DESCRIPTION OF THE DRAWINGS

FIG. 1 is a block diagram overview of an ITR system according to some embodiments of the present invention.

FIG. 2 is a flow chart of a method according to some embodiments of the present invention.

FIG. 3 is a block diagram overview of an ITR system according to some embodiments of the present invention.

FIG. 4 is an information flow diagram according to some embodiments of the present invention.

FIG. 5 is an information flow diagram according to some embodiments of the present invention.

FIG. 6 is a block diagram of an ITR controller according to some embodiments of the present invention.

FIG. 7 is a tabular representation of a portion of an ITR information database according to some embodiments of the present invention.

FIG. 8 is a tabular representation of a portion of a Risk Management Clearinghouse database according to some embodiments of the present invention.

FIG. 9 is a flow chart of a computer-implemented method to facilitate filing an ITR, according to some embodiments of the present invention.

FIG. 10 is a flow chart of an additional automated method to facilitate filing an ITR, according to some embodiments of the present invention.

### DETAILED DESCRIPTION

Embodiments of the present invention are associated with systems and methods to facilitate gathering and processing information related to a management of risk associated with insider trading activity. ITR can be contained by monitoring transaction activity and relating data descriptive of the transaction activity with information descriptive of risk variables, such as the identities of corporate insiders and events in an industry that can affect a market price of a one or more securities. As used herein, the Insider Trading Risk (ITR) may refer to any risk associated with activities relating to insider trading that is proscribed by law, such as those activities set forth in 17 CFR 240, 243 and 249, other Securities and Exchange Commission (SEC) regulations or other rules promulgated by a designated authority.

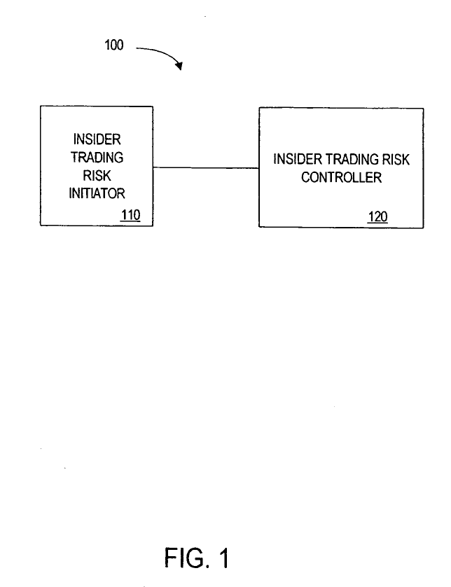

Turning now in detail to the drawings, FIG. 1 is a block diagram of an ITR system 100 according to some embodiments of the present invention. As shown in FIG. 1, an ITR initiator 110 may communicate with an ITR controller 120. For example, the ITR initiator 110 (e.g., a Financial Institution employee or an automated trading system or back end system observing financial transactions or proposed financial transactions) may transmit to the ITR controller 120 information relating to a financial transaction. The ITR controller 120 can compare the information relating to a financial transaction to gathered data descriptive of Insider Trading rules, laws, regulations and guidelines which can be stored in a computer database. In addition, gathered data can include information relating to industry variables and market conditions. The comparison of data can generate an indication of an amount of ITR associated with a particular transaction.

For example, a trading system can receive an order to sell a particular security on behalf of a particular account holder. Before consummating the trade, an electronic link can transmit data descriptive of the proposed transaction to the ITR controller 120. The ITR controller may determine that the account holder is an officer of company and that quarterly data is scheduled to be released within a few days.

As in the above example, an ITR initiator 110 transmitting information to the ITR controller 120 relating to insider trading can be an employee or other person associated with a Financial Institution or an automated process programmed into a trading system.

A Financial Institution can include, for example: an insured bank, a savings association, a savings association service corporation, a credit union, a bank holding company, a non-bank subsidiary of a bank holding company, an Edge and Agreement corporation, a U.S. branch or agency of a foreign bank, or other entity. An Edge Act and Agreement Corporation i s a foreign bank office chartered by the Federal Reserve (Edge Act) or a state (representative corporations) to provide financing for international trade. Domestic banking organizations may also establish Edge Act or agreement corporations. These offices have a broader range of powers than other banking organizations, but all of their activities must relate to international trade. Other structures available to foreign banks, and which can also be considered financial institutions include commercial lending corporations and export trading companies.

The ITR controller can be programmed to ascertain indications of any high Risk scenarios related to insider trading. For example, risk associated with Regulation FD (Fair Disclosure) addresses selective disclosure. Risk associated with Regulation FD can be related to instances when an issuer, or person acting on the issuer's behalf, discloses material nonpublic information to certain enumerated persons (in general, securities market professionals and holders of the issuer's securities who may well trade on the basis of the information), it must make public disclosure of that information.

The ITR controller 120 can provide one or more indications of risk based upon variables gathered into the ITR controller 120, such as variables related to timing of a required public disclosure which can depend on whether the selective disclosure was intentional or non-intentional. For an intentional selective disclosure, an issuer must make public disclosure simultaneously; for a non-intentional disclosure, the issuer must make public disclosure promptly. Under the regulation, the required public disclosure may be made by filing or furnishing a Form 8-K, or by another method or combination of methods that is reasonably designed to effect broad, non-exclusionary distribution of the information to the public.

The ITR controller 120 can gather data descriptive of such variables and compare the variable data to the data received that is descriptive of a pending transaction. If the comparison generates an indication of a potential for high risk related to the variables and the received data, the ITR controller 120 can generate an indication of the amount of Risk associated with the transaction.

Other ITR determined by the ITR controller 120 can include Risk associated with Rule 10b5-1 which addresses the issue of when insider trading liability arises in connection with a trader's “use” or “knowing possession” of material nonpublic information. Rule 10b5-1 provides that a person trades “on the basis of” material nonpublic information when the person purchases or sells securities while aware of the information. However, Rule 10b5-1 also sets forth several affirmative defenses, for which algorithms can also be programmed into the ITR controller 120, and be utilized to mitigate indications of Risk. For example, defenses can include a modified response to comments, which can permit a person to trade in certain circumstances where it is clear that the information was not a factor in the decision to trade.

Still other ITR can include; for example, ITR associated with Rule 10b5-2 which addresses the issue of when a breach of a family or other non-business relationship may give rise to liability under the misappropriation theory of insider trading. The ITR can be programmed to check for three non-exclusive bases for determining that a duty of trust or confidence was owed by a person receiving information.

In some embodiments, in addition to a Financial Institution, other parties, such as the SEC, investors, policy makers or others who may be concerned about selective disclosure of material information by issuers can also access an ITR controller 120 to determine the probability of high ITR related to issuers disclosing important nonpublic information, such as advance warnings of earnings results to securities analysts or selected institutional investors or both, before making full disclosure of the same information to the general public. Parties privy to the information beforehand may be able to make a profit or avoid a loss at the expense of those kept in the dark. The practice of selective disclosure may have negative consequences, such as a loss of investor confidence in the integrity of capital markets. Indications of insider trading can include, for example, a security's price changing dramatically and subsequently followed by the disclosure of information responsible, such that the general public may not have been on a level playing field with market insiders.

Other IR can include issuer selective disclosure which bears a close resemblance in this regard to ordinary “tipping” and insider trading. In both cases, the ITR controller 120 can check for a privileged few that may have gained an informational edge, and the ability to use that edge for profit due to superior access to corporate insiders, rather than from any particular skill, acumen, or diligence.

According to the present invention, an ITR controller 120 can be instrumental in preventing or discerning selective disclosure which may have an adverse impact on market integrity that is similar to the adverse impact from illegal insider trading: investors lose confidence in the fairness of the markets when they know that other participants may exploit “unerodable informational advantages” derived not from hard work or insights, but from their access to corporate insiders. The ITR controller can therefore facilitate the prevention of any association with tipping and insider trading which can be severely punished under antifraud provisions of federal securities laws, ion particular in cases where the status of an issuer selective disclosure may be less than clear.

Similarly, the present invention can implement an ITR controller 120 to ascertain indications of violations of Regulation FD which relate to the potential for corporate management to treat material information as a commodity to be used to gain or maintain favor with particular analysts or investors. In the absence of a system and method to readily ascertain selective disclosure, analysts may be tempted to report favorably about a company or otherwise slant their analysis in order to have continued access to selectively disclosed information. In this case the ITR may be able to generate indications of a favorable report given to prevent retribution for publication of negative views of an issuer which can then result in the analyst being excluded by that issuer from calls and meetings to which other analysts are invited.

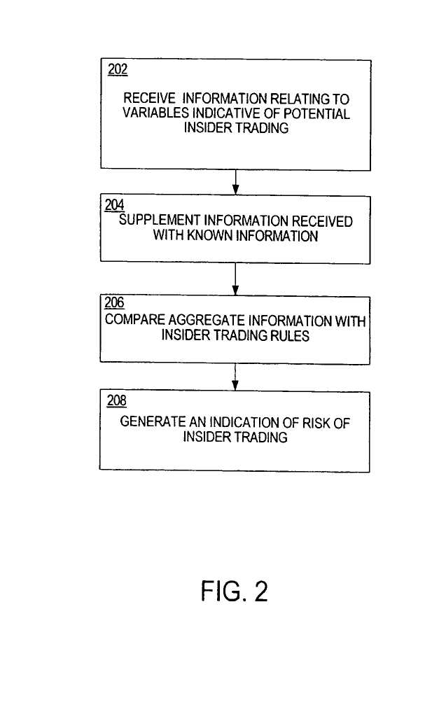

FIG. 2 is a flow chart of a method according to some embodiments of the present invention. The flow chart of FIG. 2 and the other flow charts described herein do not imply a fixed order to the steps, and some embodiments of the present invention can be practiced in any order that is practicable. The method shown in FIG. 2 may be performed, for example, by the ITR controller 120.

At 202, information relating to insider trading is received from an ITR initiator 110. According to some embodiments of the present invention, the information can be received as electronic data via an electronic form that prompts the ITR initiator 110 for specific information. Consider, for example, a bank employee who wants to report details of a transaction, or a back end system transmitting information as a normal course of business. In this case, the ITR controller 120 may present to the bank employee an electronic form prompting the bank employee to provide information (e.g., via a Web site associated with the ITR controller 120). The electronic form may include, for example: a defined data field for entering a type of insider trading to be screened; identification of the transactor, a description of the transaction and other related information. In addition, the ITR controller 120 may receive supporting documentation from the ITR initiator 110 (e.g., electronic document, scanned image of a hardcopy document, an indication of where to locate supporting documentation, or other description of supporting documentation).

Other information that can be received can include records from a risk management clearinghouse (RMC) search or other data source which relate to information received into the electronic form. In some embodiments, the RMC can include a variety of information systems that gather information related to entities traded on national exchanges, officers of such entities, board members, public documents and news documents that may indicate a relationship of a transactor with a person who may be privy to insider information.

At 204, received information is stored as data in a computer database. The computer database can facilitate organization and retrieval of the information as well as generate reports including the stored information. For example, the ITR controller 120 may store all received information relating to insider trading. Once stored, the ITR controller can correlate information received on disparate occasions and/or under disparate circumstances. For example, data descriptive of a transaction selling a stock short in New York may correlate with trades in Chicago by a business associate of a corporate officer. Such correlation can be made according to direct links built into a structure utilized by the database and/or as a result of data scrubbing or augmenting techniques described further below.

At 206, an ITR is generated based upon the information that has been received and stored. The generated ITR comprises the received information and can be in electronic format and/or also reproducible in hardcopy form.

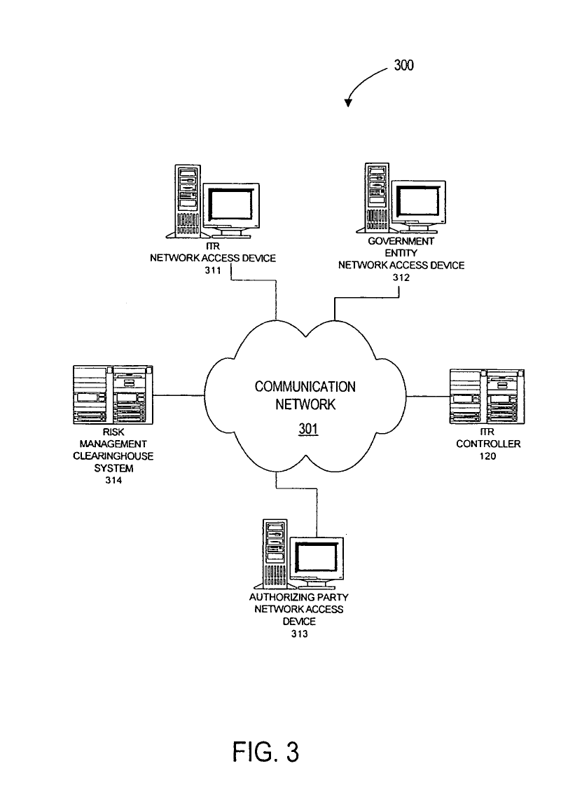

ITR System Overview FIG. 3 is a block diagram of a system 300 according to some embodiments of the present invention. The system 300 includes an ITR controller 120 in communication with other devices.

As shown in FIG. 3, devices (such as an ITR controller 120, a network access device 311-313, an ITR network access device 311, a government entity network access device 312, an authorizing party network access device 313 or other network access device) may communicate via a communication network 301, such as a Local Area Network (LAN), a Metropolitan Area Network (MAN), a Wide Area Network (WAN), a proprietary network, a Public Switched Telephone Network (PSTN), a Wireless Application Protocol (WAP) network, a wireless LAN (e.g., in accordance with the Institute of Electrical and Electronics Engineers 802.11 standard), a Bluetooth network, an Infrared Radiation (IR) network, and/or an IP network such as the Internet, an intranet or an extranet.

As used herein, the term “communication” can refer to wired and/or wireless communication as appropriate. Note that the devices shown in FIG. 3 need not be in constant communication. For example, the ITR controller 120 may communicate with a network access device 311-313 on an as-needed or periodic basis. Communication can be utilized to receive, input, transmit or view information processed or stored in the ITR controller 120.

Although a single ITR controller 120 is shown in FIG. 3, any number of ITR controllers 120 may be included in the system 300. Similarly, any number of network access devices 311-313, or any of the other devices described herein, may be included in the ITR system 300 according to embodiments of the present invention.

The ITR controller 120 and the network access device 311-313 may be any devices capable of performing the various functions described herein. A network access device 311-313 may be, for example: a wireless telephone 322, a PDA 324, or an information recording device 326 (e.g., an observation camera). Other examples of a network access device 311-313 include a Personal Computer (PC), a portable computing device, a wired telephone, a kiosk, such as an Automated Teller Machine, an interactive television device, and a one-way or two-way pager.

Each network access device 311-313, 311-313 utilized to access the ITR controller 120 can include a processor, memory and a user input device, such as a keyboard, mouse, touch screen or other device and a user output device, such as a display screen and/or printer. In some embodiments, a network access device 311-313 may be associated with an ITR initiator 110, authorizing party, government agent, or any party who is authorized to interact with the ITR Reporting controller 310.

Accordingly, embodiments can include various types of network access devices, such as: ITR initiator device 311 accessed by an ITR initiator 110; a government entity device 312 which is accessed by an appropriate government or law enforcement entity; and an authorizing party device 313 accessed by a party designated to authorize filing of an ITR.

In some embodiments, a determination of whether to file an ITR and/or actual filing of an ITR can be facilitated by utilizing resources provided by the RMC system 314 (further described in other documents). As such, information gathering, record keeping and prevention of insider trading as required the CFR and other obligations can be automated and utilized to facilitate corporate governance. A RMC system 314 can include a computer server with a processor and a memory.

Accordingly, the ITR controller 120 can gather additional data relating to the received information from the ITR initiator device 311, such as, for example data resulting from a RMC search conducted by a RMC system 314. The ITR controller 120 can also transmit data to implement a related RMC search to a RMC system 314 or other data source. In some embodiments, the RMC system 314 can be combined with the ITR controller into one computer server. In some embodiments, a RMC system 314 may include multiple processing and database sub-systems, such as cooperative or redundant processing and/or database servers that can be geographically dispersed throughout the network.

In some embodiments, the ITR controller 120 can transmit ITR related information to an authorizing party device 313 where it can be presented to an authorizing party. In addition, some embodiments can include the ITR controller 120 transmitting results of a RMC search to an authorizing party device 313 or causing the RMC system 314 to transmit the RMC search results directly to the authorizing party device 313.

If it is determined that a document should be submitted to a government entity, such as a Form 8-K, Form 4, Form 5 or other form, the ITR controller 120 can transmit relevant information to an appropriate government device 312 or other regulatory destination. Transmission to the government entity device can include electronic mail, facsimile, file transmitting protocol transmission, hardcopy, or other medium.

Typically the ITR controller 120 can be communicated utilizing client software executed at a network access device 310, 311-313. The client software may include a generic hypertext markup language (HTML) browser, such as Netscape Navigator or Microsoft Internet Explorer, (a “WEB browser”). The client software may also be a proprietary browser, and/or other host access software. In some embodiments, an executable program, such as a Java™ program, may be downloaded from the ITR controller 120 to the network access device 310, 311-313 and executed at the network access device 310, 311-313. Some implementations can also include proprietary software installed from a computer readable medium, such as a CD-ROM. Inventive concepts may therefore be implemented in digital electronic circuitry, computer hardware, firmware, software, or in combinations of the above. Data can be generated, received, transmitted, processed and stored as digital data. Some apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output.

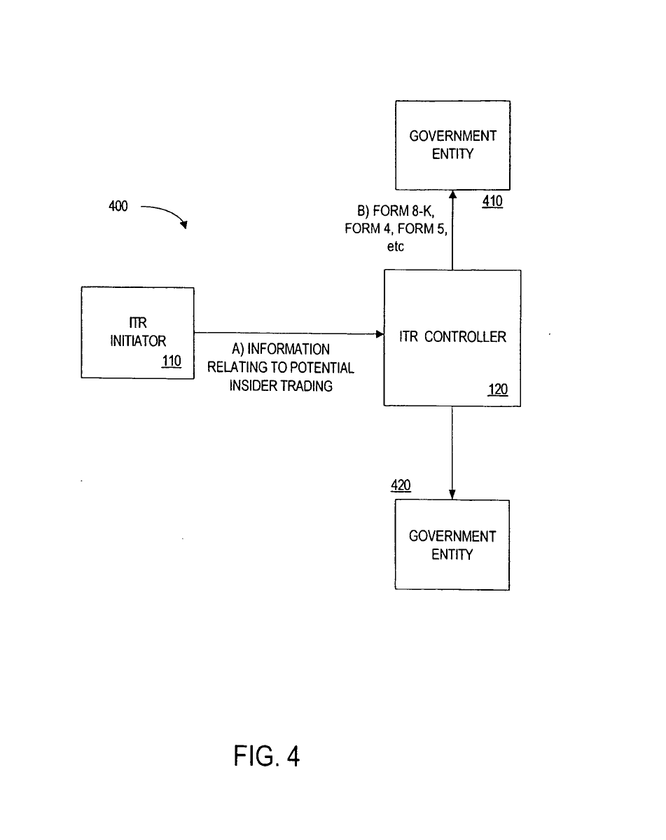

FIG. 4 is an information flow diagram 400 according to some embodiments of the present invention. As shown in FIG. 4, an ITR initiator 110 transmits information related to insider trading to the ITR controller 120 at (A). If warranted, the ITR controller 120 then transmits a relevant form to a designated government entity 410 at (B). In addition, the ITR Controller 120 stores the information received and an image of the ITR transmitted to the government entity 410. Note that the information illustrated in FIG. 4 may be exchanged via a number of different communication networks. For example, the ITR initiator 110 may communicate with the ITR controller 120 via a first communication network (e.g., private Local Area Network) and the ITR controller 120 with the government entity 410 via a second communication network (e.g., the Internet).

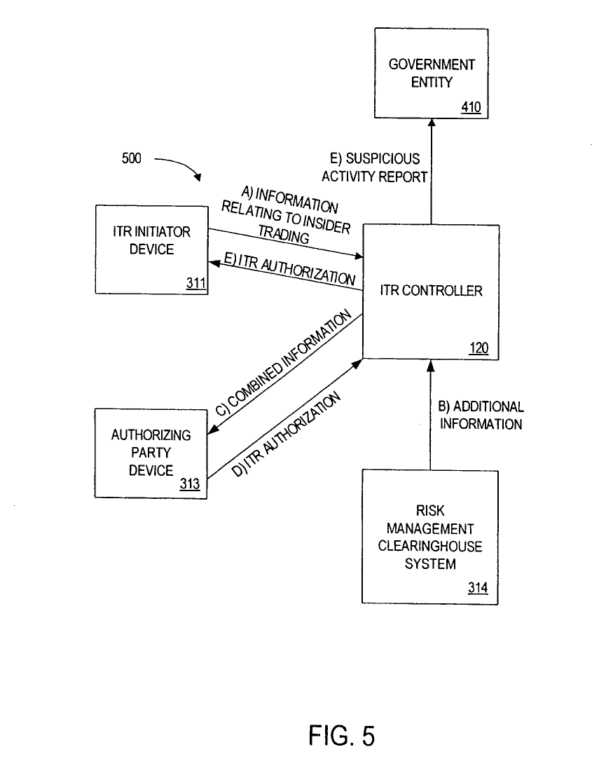

FIG. 5 is an information flow diagram 500 according to some embodiments of the present invention. As before, ITR initiator 110 transmits information descriptive of insider trading to the ITR controller 120 at (A). In this case, however, a RMC system also transmits additional RMC information related to the insider trading information, industry news, market events, public documents, relationships of prominent persons, or any other relevant data to the ITR controller 120 at (B).

In some embodiments, the ITR controller 120 can forward the combined information, including the insider trading information and the RMC information to an authorizing party 420 at (C). An authorizing party 520 can include, for example, a lawyer or compliance officer within a financial institution charged with determining whether a transaction should proceed taking into consideration: the data collected, the requirements under the law, the interests of the financial institution, the interests of the financial institution's clients, public interest, and other considerations. The authorizing party 520 can convey to the ITR controller 120 an indication of authorization to proceed, or take some alternative action, at D.

In some embodiments, the authorizing party 520 will transmit an indication of no authorization to proceed, at D. In these cases, an alternative will take place, such as filing a required Form with a government entity.

If the ITR controller 120 receives an indication to file a form, at D, the ITR controller 120 can transmit the form, or data related to the form to the government entity 410, at E. The filed form can include required datum or information as well as supporting documentation, if such documentation is available.

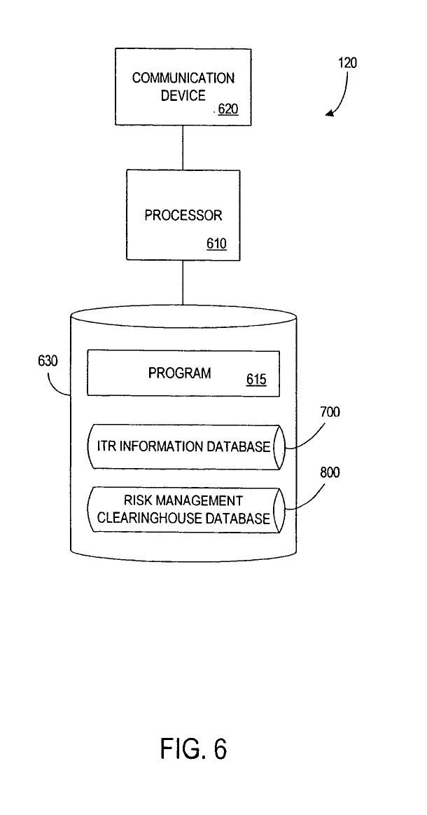

An example of an ITR controller 120 that may be used in connection with the communication systems 100, 300 discussed herein will now be described in detail with respect to FIGS. 6 through 13.

Communication Controller

FIG. 6 illustrates an ITR controller 120 that is descriptive of the devices shown, for example, in FIGS. 1 and 3 according to some embodiments of the present invention. The ITR controller 120 comprises a processor 610, such as one or more INTEL® processors, coupled to a communication device 620 configured to communicate via a communication network (not shown in FIG. 6). The communication device 620 may be used to communicate, for example, with one or more network access devices 311-313, ITR initiator device 311, government entity device 312, authorizing party device 313, and/or RMC system 314.

The processor 610 is also in communication with a storage device 630. The storage device 630 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 630 stores a program 615 for controlling the processor 610. The processor 610 performs instructions of the program 615, and thereby operates in accordance with the present invention. For example, the processor 610 may receive an indication to file an ITR with a government entity 410. The processor 610 may also transmit information comprising the ITR to appreciate destinations.

According to other embodiments, the processor 610 receives from an ITR initiator 110 information relating to the insider trading. The processor 610 generates an indication of ITR associated with a transaction and transmits indication, such as an authorizing party 420, or other entity.

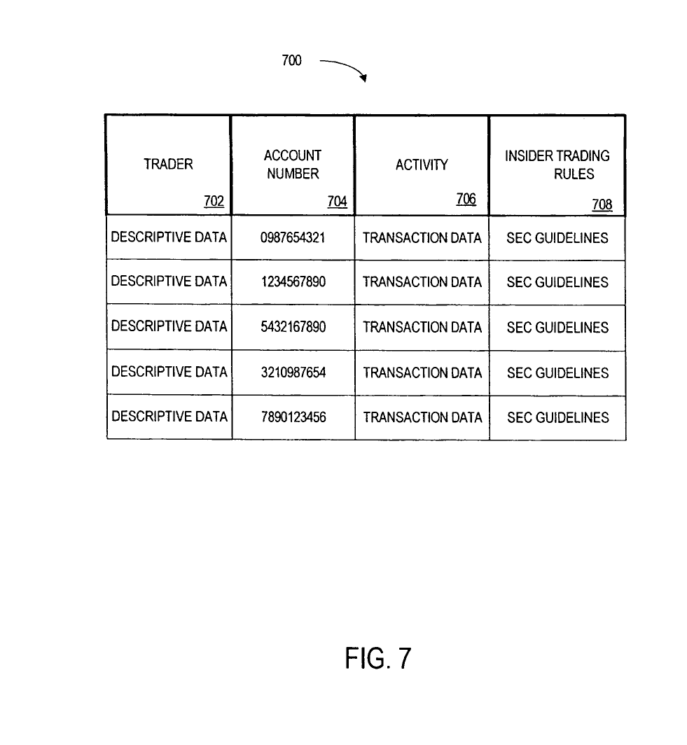

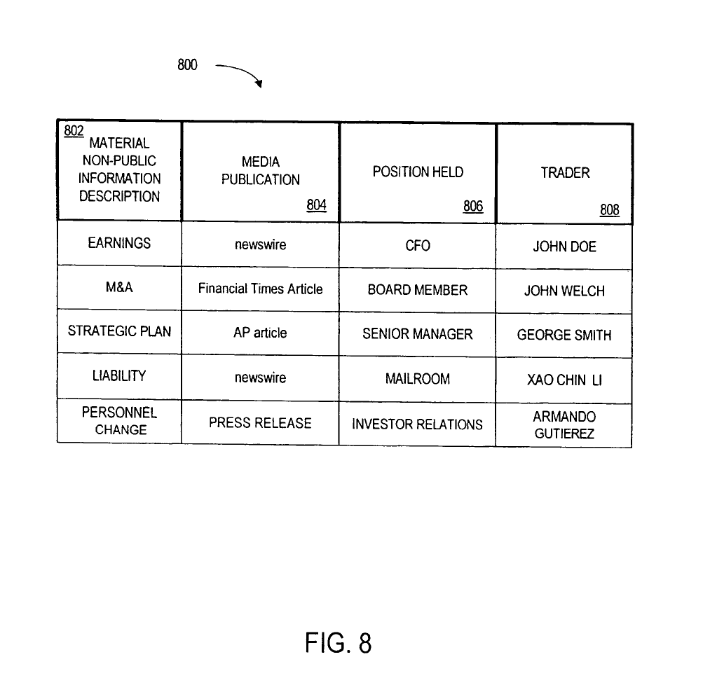

The storage device 630 can store an ITR information database 700 (described with respect to FIG. 7) and a RMC database 800 (described with respect to FIG. 8). The illustrations and accompanying descriptions of the databases presented herein are exemplary, and any number of other database arrangements could be employed besides those suggested by the figures.

ITR Information Database

Referring to FIG. 7, a table represents the ITR information database 700 that may be stored at an ITR controller 120 according to some embodiments of the present invention. The table includes entries identifying a trader 702 (i.e., Social Security Number “SSN”, Employer Identification Number “EIN”, Taxpayer Identification Number “TIN”) involved with a particular transaction. The table can also define an account number 704, activity 706, and insider trading rules 708. The information in the ITR information database 700 may be created and updated, for example, by the ITR controller 120, an ITR initiator 110, authorized party 420, a RMC system 314 or other authorized entity.

The trader identifier 702 may be, for example, an alphanumeric code succinctly identifying a trader individual or entity identified with insider trading that has been received and/or processed by the ITR controller 120. The account number 704 can include multiple accounts if appropriate. The activity 706 can include any activity specified by statute or regulation or other activity that an ITR initiator 110 deems appropriate. For example, the activity 706 can include details of a security trade, a derivative order, selling short, selling long or other well know transaction type regulated under SEC or other regulatory rules.

A trader name 702 can include multiple variations of a spelling of the name, and/or aliases utilized by the trader.

In addition to the information illustrated in FIG. 7, other information can be stored in the ITR information database 700. For example, a dollar amount involved, a date, a time, and/or a location associated with insider trading, required filing dates, file retention dates, or any other pertinent data.

RMC Database

Referring to FIG. 8, a table represents the RMC information database 800 that may be stored at an ITR controller 120 according to some embodiments of the present invention. The table includes one or more entries identifying data related to ITR entries that have been received and/or processed by the ITR controller 120. The table also defines fields 802, 804, 806, 808 for each of the entries. The fields specify a description of material non-public information 802, a media publication 804, a position held 806, and a trader name 808. The information in the RMC database 800 may be created and updated, for example, as the ITR controller 120 facilitates management of ITR.

Other information may be stored in the RMC database 800 in addition to the information illustrated in FIG. 8. For example, the RMC database 800 may indicate data resulting from a scrubbing routine (e.g., field alignment, or spelling correction) and/or a source of a particular piece of information (e.g., an investigation firm, a reporting agency, a government agency). Blanks entries can indicate fields for which no data is available.

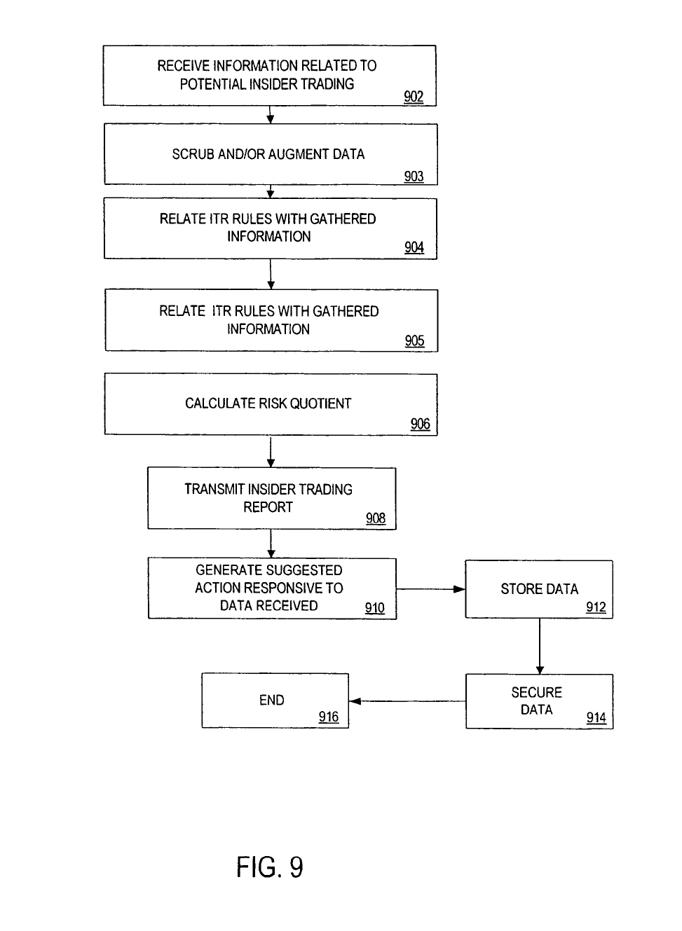

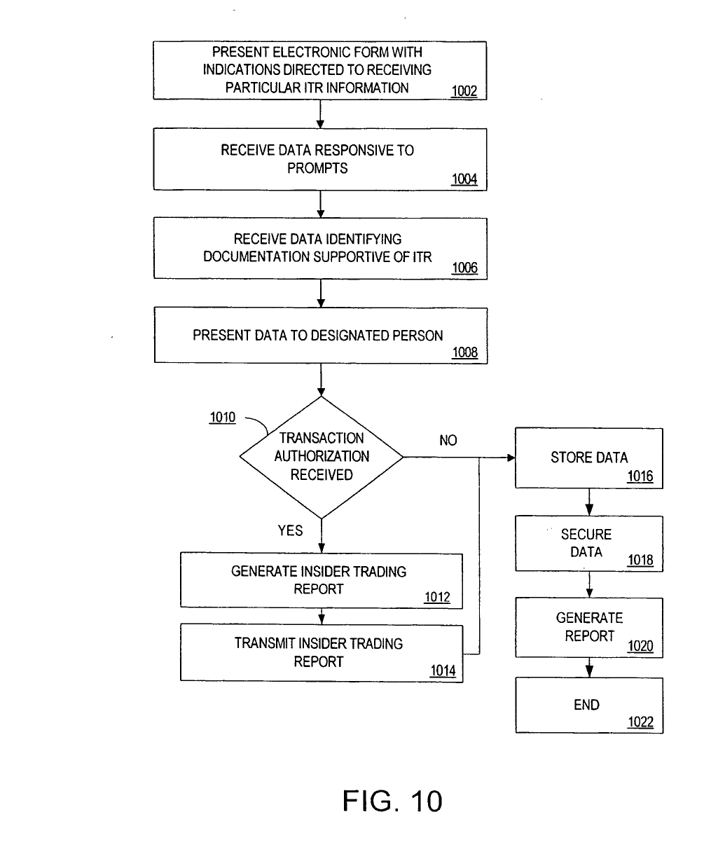

A method that may be used in connection with the ITR system 100, 300 according to some embodiments of the present invention will now be described in detail with respect to FIG. 9 and FIG. 10.

ITR System Method

FIG. 9 is a flow chart of an exemplary computer-implemented method to facilitate processing information related to an ITR and filing an ITR according to some embodiments of the present invention. The method may be performed, for example, by an ITR controller 120.

At 902, information related to insider trading is received from an ITR initiator 110. For example, an ITR controller 120 may receive the information via a form presenting entry points for data fields in a graphical user interface (GUI) presented on an ITR initiator device 311. The information can include, for example a description of the insider trading, the name of the trader, a date a transaction occurred, date the insider trading was detected, accounts involved, dollar amounts involved and other data. Hard copy information can be scanned, or otherwise converted to an electronic format so that it can be received by the ITR controller 120.

The received information can also include documentation supporting the ITR, such as a business record equivalent. Other types of supporting documentation can include a video clip captured by a monitor recording a transaction or other type of documentation.

At 903, some embodiments can include data scrubbing to implement receiving and storing received ITR data. Data scrubbing can access information from multiple data sources and store it in a manner that gives more efficient and flexible access to key facts. Data scrubbing routines can include, for example, programs capable of correcting a specific type of mistake, such as an incomprehensible address, or clean up a full spectrum of commonly found database flaws, such as field alignment (ascertain misplaced data and move it to a correct field) or removing inconsistencies and inaccuracies from like data.

A scrubbing routine can be useful, for example, to facilitate coordination of related terms utilized in different areas of a financial institution, various government agencies or other source of information. A data scrubbing routine can be programmed to facilitate association of multiple spellings of an equivalent term or name, inconsistencies in related data fields (e.g., mismatch of a city and zip code or an equivalent phone number utilized for disparate accounts and account holders); different terminology utilized for similar functions; or other important information. Receiving data with such a routine can enhance the value of the data received and also help correct database flaws. In some embodiments, data scrubbing routines can improve and expand data quality more efficiently than manual mending of received data.

The data received can include, for example, text information, audio and/or video information (e.g., recording from an observation video camera), biometric information (e.g., a fingerprint image, retina scan, facial image); and/or image information (e.g., a scanned image of a document, signature, or other captured image).

Augmenting data can include implementing data mining techniques which utilize software to analyze and sift through aggregated data using mathematical modeling, statistical analysis, pattern recognition, rule based trends or other data analysis tools. Data stored or retrieved utilizing augmenting techniques can provide ITR related data storage with a discovery dimension that a human operator with hard copy documents may find labor and cognitively intense. For example, augmented data may determine that statistically it is highly improbable that a recorded pattern of transactions could have taken place without coordination between parties involved, which may in turn indicate conveyance of insider information.

At 904, the ITR controller 120 can relate ITR rules to gathered data. At 950 the ITR rules can be related to gathered information, such as, from an RMC. At 906, a risk quotient, or other indicator of an amount of ITR associated with a transaction can be generated and at 908 a report descriptive of insider trading can be transmitted to a designated destination.

At 910, some embodiments can also include the ITR controller 120 generating a suggested action responsive to the information received (e.g., ITR information and RMC information). For example, a suggested action can include an automated analysis of the data and a recommendation that an ITR be filed, that an account be monitored, that an account be closed, that an employee of the financial institution involved be monitored or terminated, or other action.

At 912 the ITR controller 120 can store any or all related data can be stored for later retrieval, such as, for example in compliance with statutory record retention obligations, for analysis by the financial institution, for procurement to an authorized law enforcement agency, or other purpose. Step 914 indicates the stored data can be secured. Securing data can include encryption, password protection, archiving in a secure location, and other well known processes. Securing the data can include notifying appropriate employees that information relating to a filed ITR may be protected from disclosure in response to subpoena. For example, access to ITR information may be preceded by a notice that the confidentiality of the information is protected by law and that any requested or subpoenaed disclosure may be declined subject to approval by FinCEN or other appropriate law enforcement agency. At 916, this exemplary portion of an automated ITR system routine is terminated.

FIG. 10 is another flow chart of an exemplary computer-implemented method to facilitate processing information related to an ITR and filing an ITR according to some embodiments of the present invention. The method may be performed, for example, by an ITR controller 120.

At 1002 an electronic form can be presented including prompts, headings or other indications of particular ITR related information that should be received by the ITR controller 120. At 1004 the ITR related information responsive to the indications present in the GUI can be received by the ITR controller 120. In addition, at 1006, data including or identifying documents supportive of the ITR can also be received by the ITR controller 120. Received data can be formatted and presented to a designated person 1008, such as for example, an authorizing party 420 or the ITR initiator 110.

At 1010 if authorization to proceed with the transaction is received, the ITR controller 120 can generate a message indicative of the authorization at 1012 and file the ITR at 1014, such as via electronic mail, fax transmission, or hard copy generation and submission.

At 1016 any or all related data can be stored for later retrieval, such as, for example in compliance with statutory record retention obligations, for analysis by the financial institution, for procurement to an authorized law enforcement agency, or other purpose. Step 1018 indicates the stored data can be secured. Securing data can include encryption, password protection, archiving in a secure location, and other well known processes. Securing the data can include notifying appropriate employees that information relating to a filed ITR may be protected from disclosure in response to subpoena. For example, access to ITR information may be preceded by a notice that the confidentiality of the information is protected by law and that any requested or subpoenaed disclosure may be declined subject to approval by an appropriate law enforcement agency.

In addition, some embodiments can include the ITR controller 120 analyzing data received into the ITR controller 120 and presenting reports or other structured output.

At 1020, reports can be generated based upon the stored data. Reports can be presented via hardcopy, presented on a network access device 311-313 or other device 311-313, or other readable format. Reports can also accommodate a request by a user, such as an authorizing party 420, to specify certain records, such as all transactions with an ITR above a designated threshold with in a specific date range, or a report sorted according to a particular data field or criteria. At 1022, this exemplary portion of an automated ITR system routine is terminated.

Additional Embodiments

The following illustrates various additional embodiments of the present invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although many of the embodiments described herein are associated with an ITR controller 120 facilitating ITR processing and filing, according to other embodiments network access devices 311-313 or other devices 311-313 can communicate with each other to perform functions described herein, (e.g., insider trading initiator 110 can interact with a network access device 311-313 and utilize an appropriate protocol, such as peer-to-peer communications, to transmit ITR related information to an authorizing party device 313, or in still other embodiments to a RMC system 313 (including a proprietary risk management clearinghouse system) and ITR processing and filing can be facilitated via steps and processes described above but performed by the receiving device 313-314.

As such, the embodiments described herein are associated with an ITR controller 120 performing a number of functions. According to other embodiments, some or all of these functions can instead be performed by any of the other devices described herein.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A method of facilitating monitoring of a transactions for one or more indications of insider trading, the method comprising:
receiving digital information related to one or more financial transactions into a storage of a computer device;
creating rules which relate the digital information to insider trading rules in the computer storage; and
generating an indication that execution of the financial transaction is in violation of one or more of the insider trading rules.

2. The method of claim 1 wherein the digital information received comprises supporting documentation for the transactions.

3. The method of claim 1 wherein the indication of an amount of risk comprises a normal range of risk and an elevated amount of risk and the method additionally comprising the steps of:
determining a particular legal violation associated with an elevated level of risk; and
generating an action responsive to the particular legal violation.

4. The method of claim 1 wherein the method additionally comprises the step of transmitting an indication to block execution of the one or more financial transactions.

5. The method of claim 1 wherein the method additionally comprises the step of notifying a legal authority involved in enforcing insider trading laws of a potential violation of a law related to the execution of the financial transaction.

6. The method of claim 1, wherein the digital information is received from at least one of: (i) a bank, (ii) a broker dealer, and (iii) a national trading exchange.

7. The method of claim 1 additionally comprising the steps of:
analyzing the stored data for patterns of behavior indicative of insider trading; and
automatically generating a suggested action based upon the data.

8. The method of claim 7 wherein the suggested action comprises conveying an insider trading report to a government entity.

9. The method of claim 7 wherein the suggested action comprises initiating a risk management clearinghouse search.

10. The method of claim 7 wherein the suggested action comprises monitoring an associated account for a pattern of activity that may be indicative of a violation of a insider trading law.

11. The method of claim 7 wherein the suggested action comprises monitoring actions taken by an entity associated with the financial transaction for a pattern of activity that may be indicative of a violation of an insider trading law.

12. The method of claim 7 wherein the suggested action comprises refusing to perform a requested transaction.

13. The method of claim 7 wherein the suggested action comprises closing an account associated with the financial transaction.

14. The method of claim 7 wherein the suggested action comprises generating an insider trading report comprising details of the financial transaction and transmitting the report to a trading exchange associated with the financial transaction.

15. The method of claim 14 wherein the insider trading report is transmitted via electronic mail.

16. The method of claim 14 additionally comprising the steps of:
storing a record of the date and time of the transmission; and
storing a record of a destination of the transmission.

17. The method of claim 1 additionally comprising the step of securing the data comprising the insider trading report with at least one of: (i) encrypting the data, (ii) password protecting the data, (iii) protecting the data with a biometric access procedure, and (iv) refusing to disclose the data except where such disclosure is requested by an appropriate law enforcement or bank supervisory agency.

18. A computer implemented method of facilitating filing insider trading report, the method comprising:
presenting an electronic form for receiving information, wherein the electronic form comprises prompts directed to receiving information related to determining whether insider trading related to one or more transactions as occurred;
receiving data responsive to the prompts;
receiving data identifying documentation supporting potential insider trading activity;
storing the data responsive to the prompts and the data identifying documentation in a computer database;
presenting the data responsive to the prompts and the data identifying documentation to a person designated with determining whether to proceed with the one or more transactions;
receiving an indication to proceed with the one or more transactions; and
generating a communication comprising an instruction to proceed with the one or more transactions.

19. The method of claim 18 additionally comprising the step of:
scrubbing the data responsive to the prompts and the data identifying documentation to obtain additional related data.

20. The method of claim 19 additionally comprising the step of:
automatically initiating a risk management clearinghouse search related to at least one of (i) the data responsive to the prompts, and (ii) the data identifying documentation.

21. The method of claim 20 wherein the risk management clearinghouse search is initiated on a proprietary risk management clearinghouse system.
